(19) United States
(12) Patent Application Publication
(10) Pub. No.: US 2018/0230062 A1
(43) Pub. Date: Aug. 16, 2018

(54) Field Induced Tow Manipulation

(71) Applicant: General Electric Company, Schenectady, NY (US)

(72) Inventors: Theodore Robert Grossman, Cincinnati, OH (US); James Scott Vartuli, Rexford, NY (US); Steven Robert Hayashi, Niskayuna, NY (US)

(21) Appl. No.: 15/430,777

(22) Filed: Feb. 13, 2017

(51) Int. Cl. C04B 35/80; C04B 41/45; C04B 41/50

(52) U.S. Cl. CPC C04B 35/80; C04B 41/4535; C04B 41/5096; C04B 41/5064; C04B 41/4568

(57) ABSTRACT

Systems and methods for forming ceramic matrix composite (CMC) components are provided. The CMC component includes a reinforcement material having a plurality of filaments that are at least partially electrically conductive. The plurality of filaments are charged by a charging element with an electric charge of the same sign such that adjacent filaments are in an expanded spatial relationship relative to one another while being coated. While in the expanded spatial relationship, the filaments can also be pulled through a matrix slurry.

### FIELD

The present subject matter relates generally to ceramic matrix composite components. More specifically, the present subject matter relates to systems and methods for forming ceramic matrix composite components, in particular, ceramic matrix composite components of gas turbine engines.

### BACKGROUND

Gas turbine engine performance and efficiency may be improved by increased combustion gas temperatures. However, increased combustion temperatures can negatively impact gas turbine engine components. Accordingly, high temperature materials, such as ceramic matrix composite (CMC) materials, are being used for various components within gas turbine engines (e.g., turbine components). Because CMC materials can withstand relatively extreme temperatures, there is particular interest in utilizing CMC materials for gas turbine engine components, especially within the combustion and turbine sections of the engine. Thus, gas turbine engine performance and efficiency can be improved through the use of CMC components.

CMC materials generally include a matrix material and a reinforcement material. More particularly, CMC materials generally comprise a ceramic fiber reinforcement material embedded in a ceramic matrix material. One exemplary CMC material composition includes SiC/SiC (fiber/matrix). SiC/SiC composites are particularly attractive for gas turbine applications because of their high thermal conductivity and excellent thermal shock resistance, creep resistance, and oxidation resistance. The reinforcement material may be discontinuous short fibers dispersed in the matrix material or continuous fibers or fiber bundles oriented within the matrix material. The reinforcement material serves as the load-bearing constituent of the CMC material, while the ceramic matrix protects the reinforcement material, maintains the orientation of its fibers, and serves to dissipate loads to the reinforcement material.

The mechanical properties and processability of CMC components are dependent upon the uniformity of one or more coatings applied to the fiber reinforcement material as well as the distribution of the matrix material about the reinforcement material. Specifically, in order to apply a more uniform coating on the filaments of the reinforcement material or to better distribute the matrix material about the reinforcement material when the filaments are drawn or fed through a matrix slurry, proper spacing between the filaments is needed. However, attempts to “spread out” or space the filaments during a coating process or through the matrix slurry have been generally ineffective.

In addition, the entrance and exit slits of the coating chamber where the filaments enter and exit have been conventionally very narrow. Once the sizing is removed from the filaments, the filaments expand due to the elastic modulus of the material. At times, a number of expanded filaments “catch” on the slits, causing broken ends and fuzz, which ultimately leads to scrap and increased production costs.

Therefore, improved methods and systems for forming CMC components would be desirable. In particular, a method for coating filaments more uniformly would be beneficial. In addition, a method for more uniformly distributing the matrix material about the reinforcement material would be desirable. Further, a method for minimizing the spatial relationship between filaments would be advantageous.

### BRIEF DESCRIPTION

Aspects and advantages of the invention will be set forth in part in the following description, or may be obvious from the description, or may be learned through practice of the invention.

In one exemplary embodiment of the present subject matter, a method for forming a CMC component that includes a plurality of filaments that are at least partially electrically conductive is provided. The method includes charging the plurality of filaments with an electrical charge such that the adjacent filaments are in an expanded spatial relationship relative to one another. The method also includes coating the plurality of filaments while the plurality of filaments are in the expanded spatial relationship.

In one exemplary aspect, the plurality of filaments are optionally coated with a silicon-doped boron nitride coating.

In another exemplary aspect, after coating, the method optionally further includes pulling the plurality of filaments through a matrix slurry while the plurality of filaments are in the expanded spatial relationship.

In yet another exemplary aspect, the plurality of filaments are coated in a coating chamber having an entrance slit, and the method optionally further includes applying opposed electric fields to the plurality of filaments such that the plurality of filaments are in a minimized spatial relationship when entering through the entrance slit.

In another exemplary embodiment of the present subject matter, a system defining a flowpath for forming a CMC component including a plurality of filaments is provided. The system includes a coating chamber positioned along the flowpath and having a coating apparatus for coating the plurality of filaments. The system also includes a charging element positioned along the flowpath and preceding the coating apparatus, the charging element configured to charge the plurality of filaments with an electrical charge such that adjacent filaments are in an expanded spatial relationship relative to one another.

In one exemplary aspect, a second charging element is optionally positioned along the flowpath and succeeding the coating chamber, the second charging element being charged with the same electrical sign as the charging element.

In another exemplary aspect, the coating chamber has an exit, and the system further optionally includes opposed inducing elements positioned along the flowpath and succeeding the coating apparatus and preceding the exit, the inducing elements located on opposite sides of the plurality of filaments and configured to apply opposing electric fields such that the plurality of filaments are in a minimized spatial relationship when drawn or fed through the exit.

In yet another exemplary aspect, the system optionally includes a second charging element positioned along the flowpath and succeeding the coating chamber. The system also includes a matrix slurry bath positioned along the flowpath and succeeding the second charging element. The system also further includes a dissipating element positioned along the flowpath and succeeding the matrix slurry bath.

In still yet another exemplary aspect, the coating chamber has an entrance and an exit, and the system optionally includes first opposed inducing elements positioned along the flowpath and preceding the entrance, the first opposed inducing elements located on opposite sides of the plurality of filaments and configured to apply opposed electric fields such that the plurality of filaments are in a minimized spatial relationship when drawn or fed through the entrance. Moreover, the system also includes second opposed inducing elements positioned along the flowpath and succeeding the coating apparatus and preceding the exit, the second opposed inducing elements located on opposite sides of the plurality of filaments and configured to apply opposed electric fields such that the plurality of filaments are in a minimized spatial relationship when drawn or fed through the exit.

In another exemplary embodiment of the present subject matter, a method for forming a CMC component that includes a plurality of filaments that are at least partially electrically conductive is provided. The method includes charging the plurality of filaments with an electrical charge such that adjacent filaments are in an expanded spatial relationship relative to one another. The method also includes pulling the plurality of filaments through a matrix slurry while the plurality of filaments are in the expanded spatial relationship.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a schematic view of an exemplary CMC component fabrication process according to an exemplary embodiment of the present subject matter;

FIG. 2 is a schematic side view of an exemplary coating system for coating a plurality of filaments according to an exemplary embodiment of the present subject matter;

FIG. 3 is a top plan view of the filaments of FIG. 2 drawn or fed over an exemplary charged roller according to an exemplary embodiment of the present subject matter;

FIG. 4 is a close-up, perspective view of two filaments of FIGS. 2 and 3 charged with the same electric sign according to exemplary embodiments of the present subject matter;

FIG. 5 shows a cross-sectional view of an exemplary filament substantially covered with a coating according to an exemplary embodiment of the present subject matter;

FIG. 6 is a schematic side view of another exemplary coating system according to exemplary embodiments of the present disclosure;

FIG. 7 is a schematic side view of another exemplary coating system according to exemplary embodiments of the present disclosure;

FIG. 8 is a close-up, side view of the filaments being drawn or fed through the opposed inducing elements of FIG. 7; and

FIG. 9 is a schematic side view of an exemplary coating system and exemplary impregnation system for fabricating a CMC component according to an exemplary embodiment of the present subject matter.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first,” “second,” and “third” may be used interchangeably to distinguish one component from another and are not intended to signify location or importance of the individual components. The terms “preceding” and “succeeding” refer to the relative direction with respect to positions along the flowpath of the CMC fabrication process. For example, “preceding” refers to a position along the flowpath that is closer to the beginning of the process and “succeeding” refers to a position along the flowpath that is closer to the end of the process.

Exemplary aspects of the present disclosure are directed to methods and systems for forming a CMC component. In one exemplary aspect, a method for forming a CMC component is provided. The CMC component includes a reinforcement material having a plurality of filaments that are at least partially electrically conductive. The plurality of filaments are charged with an electrical charge such that the plurality of filaments are in an expanded spatial relationship. To create or effect the expanded spatial relationship, the filaments are charged with the same electric sign (e.g., a positive or negative charge). The filaments charged with the same electric sign repel each other, causing the filaments to become spaced apart. Then, the filaments are coated while in the expanded spatial relationship, which allows for better gas diffusion during the coating process, leading to better processability and better mechanical properties of the final CMC component, among other benefits.

In another exemplary aspect, a system defining a flowpath for forming a CMC component is provided. The system includes a coating chamber positioned along the flowpath. The coating chamber has an entrance and an exit in which a plurality of filaments are drawn or fed through. The coating chamber has a coating apparatus for coating the plurality of filaments. The system further includes one or more rollers for drawing or feeding the plurality of filaments along the flowpath and through the entrance and exit of the coating chamber. Moreover, a charging element positioned preceding the coating apparatus along the flowpath charges the filaments with an electrical charge such that the filaments are in an expanded spatial relationship when coated by the coating apparatus. The system also includes an impregnation system for impregnating the plurality of filaments with matrix materials. The impregnation system includes a matrix slurry vessel or bath that contains a matrix slurry. A second charging element precedes the matrix slurry vessel and either charges or recharges the plurality of filaments as necessary before they enter the matrix slurry vessel. In this manner, the filaments are pulled through the matrix slurry while in an expanded relationship.

In yet another exemplary aspect, a method for forming a CMC component is provided. The CMC component includes a plurality of filaments that are at least partially electrically conductive. The plurality of filaments are charged with an electrical charge such that the plurality of filaments are in an expanded spatial relationship. To create the expanded spatial relationship, the filaments are charged with the same electric sign. Then, while the filaments are in the expanded spatial relationship, the filaments are pulled through a matrix slurry, allowing for better distribution of the matrix material about the filaments, leading to better mechanical properties of the finished CMC component and to better processability, among other benefits.

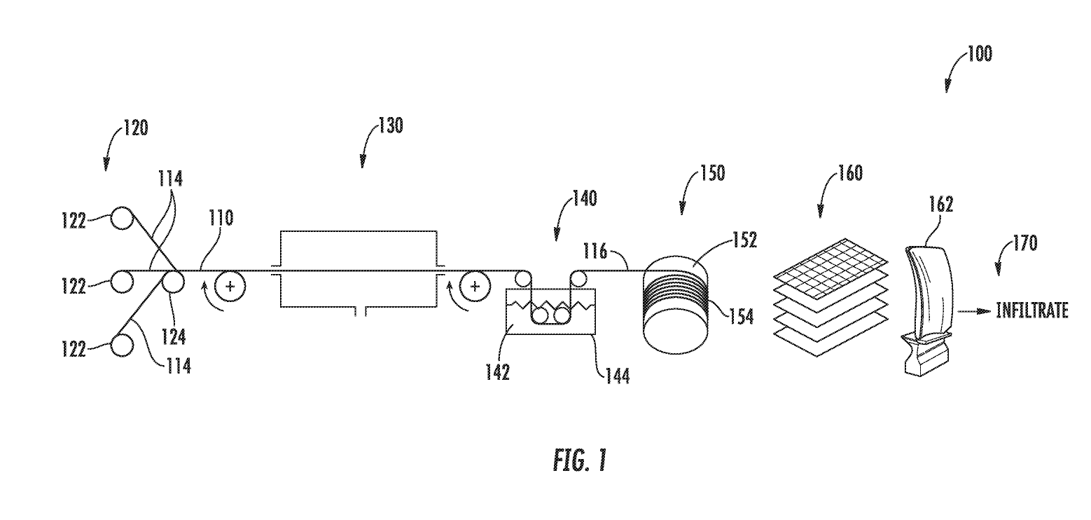

Turning now to the drawings, FIG. 1 provides a schematic view of an exemplary CMC fabrication process 100. More particularly, an exemplary prepreg process used for the fabrication of CMC components is provided. The CMC fabrication process 100 begins with unwinding 120 a SiC multi-filament fiber, which may be a Hi-Nicalon™ or Sylramic™ fiber, for example. Individual filaments 114 are unwound from drums or spindles 122 and are routed to a roller 124 where the individual filaments 114 are arranged into a plurality of filaments 110. The plurality of filaments 110 are positioned in a side-by-side relationship and oriented generally in a plane orthogonal to a vertical direction V. During the unwind process 120, tension of the plurality of filaments 110 is carefully controlled, since too much tension could damage the filaments 110 while not enough tension can allow the filaments 110 to jump off roller 124 and mis-track. Tension can also affect filament spacing which, in turn, can affect coating thickness uniformity and the distribution of matrix material about the fiber filaments 100.

In some exemplary alternative embodiments, the filaments 110 can be arranged in a woven or non-woven fiber structure, such as e.g., a sheet, a web sheet, and/or a mat. The woven fiber structure may be a two-dimensional fiber structure, three dimensional fiber structure, or a combination thereof, for example. As used herein, the filaments 110 can be disposed in any suitable arrangement for processing, such as e.g., in a side-by-side relationship in a plane orthogonal to a vertical direction V or in a woven fiber structure as noted above.

After the plurality of filaments 110 are unwound, the filaments 110 undergo a coating process 130. The coating process 130 may include multiple coating applications. The fibers may be coated for several purposes, such as to protect them during composite processing, to modify fiber-matrix interface strength, and to promote or prevent mechanical and/or chemical bonding of the fiber and matrix material, among other reasons. A number of different surface treatment techniques have been developed for applying fiber coatings, such as slurry-dipping, sol-gel, sputtering, chemical vapor deposition (CVD), and physical vapor deposition (PVD). For this embodiment, a CVD machine is used to coat the plurality of filaments 110.

After coating 130, the plurality of filaments 110 are impregnated 140 with a matrix slurry 142. Specifically, the filaments 110 are pulled through a matrix slurry bath or vessel 144 that includes the non-aqueous preform matrix slurry 142 to impregnate the fiber with matrix materials. The matrix slurry 142 contains ceramic precursor(s) and binders, among other possible elements. Preferred materials for the precursor will depend on the particular composition desired for the ceramic matrix of the CMC component, for example, SiC powder and/or one or more carbon-containing materials if the desired matrix material is SiC. Notable carbon-containing materials include carbon black, phenolic resins, and furanic resins, including furfuryl alcohol (C₄H₃OCH₂OH). Other typical slurry ingredients include organic binders (for example, polyvinyl butyral (PVB)) that promote the flexibility of prepreg tapes, and solvents for the binders (for example, toluene and/or methyl isobutyl ketone (MIBK)) that promote the fluidity of the matrix slurry 142 to better enable impregnation of the fiber reinforcement material. The matrix slurry 142 may further contain one or more particulate fillers intended to be present in the ceramic matrix of the CMC component, for example, silicon and/or SiC powders in the case of a Si—SiC matrix.

The plurality of filaments 110 become bonded together during the impregnation process 140 to form a tow 116 that undergoes a winding process 150 or wet drum winding. The filaments 110 are wound on a drum 152 to form a unidirectional pre-impregnated tape or prepreg tape 154. The prepreg tape 154 is then dried, removed from the drum 152, cut to shape, and laid-up and laminated 160 to form a preform 162 with the desired fiber architecture. The preform 162 is then heated (fired) in a vacuum or inert atmosphere (not shown) to decompose the binders, remove the solvents, and convert the precursor to the desired ceramic matrix material. Due to decomposition of the binders, the result is a porous CMC body that may undergo densification to fill the porosity and yield the CMC component. If desirable, the preform 162 can be machined (not shown) before the preform 162 is subjected to densification.

Thereafter, the preform 162 undergoes a densification process 170. Densification 170 can be performed using any known densification technique including, but not limited to, Silcomp, melt infiltration (MI), chemical vapor infiltration (CVI), polymer infiltration and pyrolysis (PIP), and oxide/oxide processes. As an example, densification can be conducted in a vacuum furnace having an established atmosphere at temperatures above 1200° C. to allow silicon or other materials to melt-infiltrate into the preform 162 and thereby fill any porosity within the matrix material. Further, the CMC component may be machined as needed (not shown). Process 100 results in a fabricated CMC component.

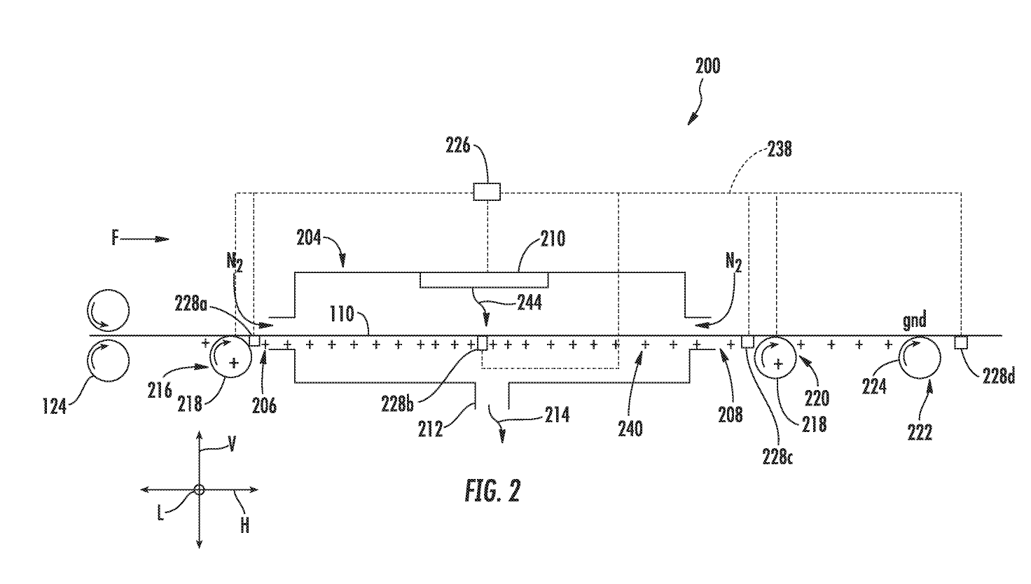

FIG. 2 is a schematic side view of an exemplary coating system 200 for performing the coating process 130 of the CMC fabrication process 100. The coating system 200 defines a vertical direction V, a horizontal direction H, and a lateral direction L (going into an out of the page in FIG. 2). The vertical direction V, horizontal direction H, and lateral direction L are mutually perpendicular and form an orthogonal direction system.

For this embodiment, the coating process 130 is a continuous, in-line fiber coating process. As shown, one or more rollers 124 draw or feed the plurality of filaments 100 along a flowpath F defined along the horizontal direction H. The filaments 100 are drawn or fed into a coating chamber 204 through an entrance slit 206 and exit the coating chamber 204 through an exit slit 208. The coating chamber 204 defines the entrance and exit slits 206, 208. Nitrogen N₂ is purged into the coating chamber 204 through the entrance slit 206 and the exit slit 208 such that an inert atmosphere is maintained within the coating chamber 204. Other inert gases, such as Ar, can also be used. Purging an inert gas into the coating chamber 204 prevents water vapor from contaminating the air within the chamber, among other benefits. Moreover, slits 206, 208 are typically very narrow in the vertical direction V to better maintain the inert atmosphere within the coating chamber 204.

The coating chamber 204 includes a coating apparatus 210 for coating the filaments 110. Coating apparatus 210 could be any suitable apparatus for coating the filaments 110. For example, coating apparatus 210 could be a CVD machine. Furthermore, the coating chamber 204 defines an outtake 212 for removing undesirable reactant and by-product gasses 214 from the coating chamber 204.

Notably, a charging element 216 is positioned preceding the coating chamber 204. The charging element 216 is a charged roller 218 in this embodiment. Charged roller 218 may be charged in any fashion and is adapted to charge the filaments 110 as they are fed or drawn along the flowpath F. The filaments 110 are selected to be at least partially electrically conductive. Charged roller 218 may be charged with any suitable amount of charge such that a desirable amount of charge is imparted to the filaments 110 as they are fed or drawn over the roller. It will be appreciated that too much charge on the filaments 110 may break down the low pressure gasses within coating chamber 204; thus, the charge on the charged roller 218 should be selected accordingly. Representative voltages in which charged roller 218 can be charged include about 100V to about 400V. It will also be appreciated that the filaments that make up the plurality of filaments 110 may be charged with different magnitudes of charge.

As the plurality of filaments 110 are drawn or fed past the charged roller 218, which is positively charged in this example, the plurality of filaments 110 become positively charged, as denoted by the plus signs 240 along the filaments 110. As will be appreciated, filaments 110 charged with the same electrical sign repel each other, and filaments 110 charged with opposite electrical signs attract each other. In this embodiment, as each filament of the plurality of filaments 110 is charged with the same electrical sign, the individual filaments 110 repel one another, and accordingly, the filaments 110 become spaced apart from one another. The increased spacing between the filaments 110 is denoted herein as an expanded spatial relationship. Although the filaments 110 are charged with a positive charge in this embodiment, a negative charge could also have been imparted to the filaments 100.

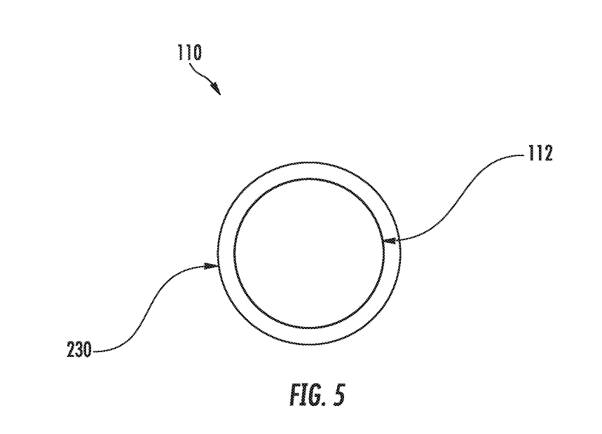

Advantageously, the expanded spatial relationship between the filaments 110 enables better gas diffusion 244 during the coating process 130 (e.g., using CVD). More uniform coatings can be achieved in part because the surfaces of the filaments 110 are more exposed in the expanded spatial relationship, as opposed to being in contact with one another, for example. Specifically, an outer surface 112 of each filament 110 can be substantially covered with a coating 230 (FIG. 5), leading to better processability and mechanical properties of the finished CMC component, among other benefits.

Once the filaments 110 are coated, they exit the coating chamber 204 through the exit slit 208 and are optionally drawn or fed over a second charging element 220. The second charging element 220 is charged with the same electric sign as the charging element 216 positioned preceding the coating chamber 204 to prevent an unsafe amount of current from flowing through the filaments 110. As shown in FIG. 2, second charging element 220 is charged with a positive electric sign; the same electric sign as the charging element 216. Second charging element 220 could be any suitable device or apparatus capable of applying a charge on the filaments 110, such as a charged roller 218 as shown in FIG. 2, or an electron gun, an ion gun, a charged particle generator, etc.

Optionally, a dissipating element 222 can be positioned succeeding the second charging element 220. Dissipating element 222, which is a grounded roller 224 in this embodiment, dissipates the charge on the filaments 110 such that the filaments 110 can be handled or transported more safely, among other possible benefits.

To control or modify the spacing between filaments 110, the amount of charge in which charging element 216 charges the filaments 110 can be set and adjusted as needed. For this embodiment, a controller 226 is in operative communication 238 (shown by dashed lines) with and sets and/or adjusts the charge of charging element 216, second charging element 220, dissipating element 222, and can set and/or adjust the charge of any other charging elements positioned along flowpath F. Operative communication 238 could be achieved wirelessly or with electrical wiring, for example. Controller 226 is also in operative communication 238 with coating apparatus 210 such that the amount of charge applied to the filaments 110 is known to the coating apparatus 210.

Controller 226 can include one or more processors, a memory, and a wireless transceiver (all not shown) and provides end user functionality. The processor(s) of controller 226 may be any suitable processing device, such as a microprocessor, microcontroller, integrated circuit, or other suitable processing device. The memory of controller 226 may include any suitable computing system or media, including, but not limited to, non-transitory computer-readable media, RAM, ROM, hard drives, flash drives, or other memory devices. The memory of controller 226 can store information accessible by processor(s) of controller 226, including instructions that can be executed by processor(s) of controller 226 in order to operate various components of coating system 200 to provide end user functionality. Input/output (“I/O”) signals may be routed between controller 226 and various operational components of coating system 200.

Sensors 228 are positioned along the flowpath F and are in operative communication 238 with controller 226. For this embodiment, a first sensor 228a is positioned along flowpath F and succeeding the charging element 216 and preceding the entrance slit 206 of the coating chamber 204. First sensor 228a monitors the charge on the filaments 110 as they enter the coating chamber 204 and reports the data to the controller 226. This ensures that the charging element 216 imparts the desired amount of charge to the filaments 100. Controller 226 can adjust the charging elements 216 as needed based on the received data.

Second sensor 228b is positioned along the flowpath F and within coating chamber 204. Second sensor 228b monitors the charge on the filaments 110 as they are drawn or fed through coating chamber 204. More specifically, second sensor 228b is positioned such that it can monitor the spatial relationship or amount of spacing between the plurality of filaments 100 as they are coated. The second sensor 228b then sends or reports the collected data to the controller 226. The controller 226 receives the data and adjusts the charge on the charging element 216 based on the data as necessary. For example, if second sensor 228b determines that there is insufficient charge to create the desired spacing between the filaments 110 for coating, then controller 226 can increase the charge of charging element 216 accordingly. Conversely, if second sensor 228b detects an unsafe or undesirable amount of charge on the filaments 110, controller 226 can decrease the amount of charge in which charging element 216 charges the filaments 110. Too much charge on the filaments 110 may breakdown the low pressure gasses within coating chamber 204, decreasing the integrity of the applied coating.

Third sensor 228c is positioned along the flowpath F and succeeding the coating chamber 204 and preceding the second charging element 220. Third sensor 228c monitors the charge on the filaments 110 after they exit the coating chamber 204 and reports the collected data to the controller 226. In this way, controller 226 can compare the charge on the filaments 110 at the location of first sensor 228a with the charge on the filaments 110 at the location of the third sensor 228c to determine if there is an unsafe or undesirable electrical potential or amount of current traveling through the filaments 110 as they are drawn or fed through the coating chamber 204. Controller 226 can adjust the charging elements 216, 220 accordingly based on the received data.

Fourth sensor 228d is positioned along the flowpath F and succeeding the dissipating element 222. Fourth sensor 228d monitors the charge on the filaments 110 after they are drawn or fed over dissipating element 222 and reports the data to the controller 226. In this manner, controller 226 can ensure that the charge on the filaments 110 has been sufficiently dissipated and can adjust the dissipating element 222 in accordance with the received data. Controller 226 can send an alert to a user interface or sound an alarm in the event the filaments 110 are charged to an unsafe level.

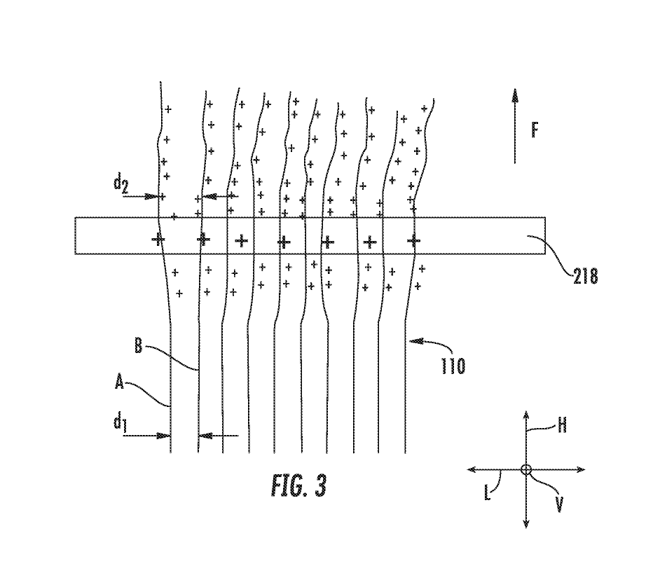

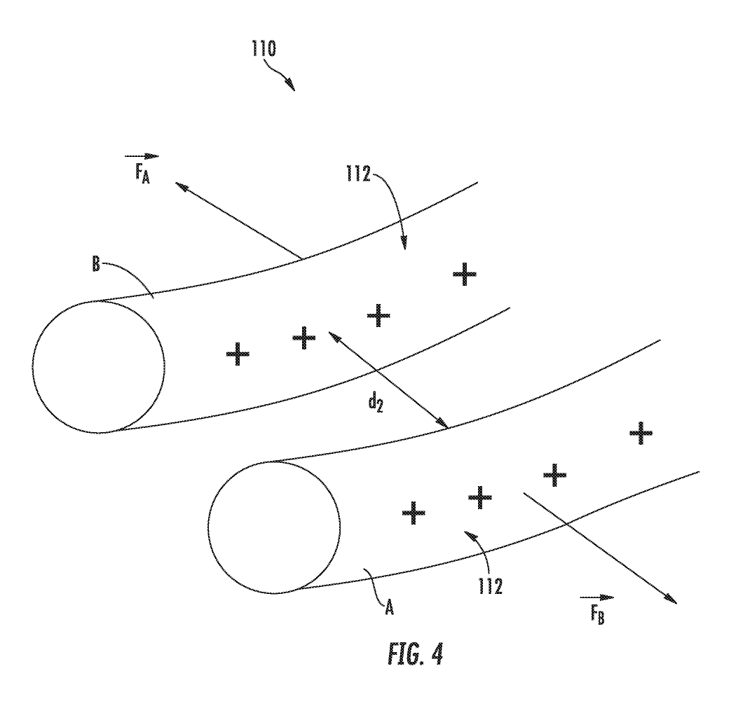

Referring now to FIGS. 3 and 4, FIG. 3 is a top plan view of the filaments 110 of FIG. 2 drawn or fed over charged roller 218 and FIG. 4 is a perspective, close-up view of two filaments of FIGS. 2 and 3 charged with the same electric sign or like electrical charge according to exemplary embodiments of the present subject matter. As shown in FIG. 3, the charged roller 218 charges the filaments 110 with a positive charge, including filaments A and B. And consequently, the filaments 110 repel one another. A distance d1 denotes the spacing between adjacent filaments A and B prior to being charged by the charged roller 218, and the distance d2 denotes the spacing between filaments A and B after being charged by the charged roller 218. When filaments A and B repel one another, the distance between them is increased. As shown, d2 is greater than d1. It will be appreciated that the filaments 110, when charged, may repel each other in the vertical direction V, the lateral direction L, or both.

As depicted in FIG. 4, filament A is positively charged and filament B is likewise positively charged, and accordingly, filament A and filament B repel each other, as noted above. Each filament experiences a force directed away from the other filament. Specifically, filament A experiences a force \vec{F_{B}} from positively charged filament B and filament B experiences a force \vec{F_{A}} from positively charged filament A as shown. The repulsive forces \vec{F_{B}} and \vec{F_{A}} expand the distance d₂ between filaments A and B. In this manner, filaments A and B are spaced apart in the expanded spatial relationship.

For this embodiment, the plurality of filaments 110 are spaced apart from one another (i.e., in the expanded spatial relationship) by about 1 to about 100 micrometers (10⁻⁶ m). In another embodiment, the plurality of filaments 110 are spaced apart from one another by about 1 to about 10 micrometers (10⁻⁶ m). In yet another embodiment, the plurality of filaments 110 are spaced apart from one another a predetermined distance. The predetermined distance is a distance in which there is sufficient space between the plurality of filaments 110 such that the outer surface 112 of each filament 110 is substantially covered by a coating 230 (see FIG. 5).

FIG. 5 shows a cross-sectional view of an exemplary filament 110 substantially covered with coating 230 according to an exemplary embodiment of the present subject matter. More specifically, the coating 230 is shown substantially covering the outer surface 112 of filament 110. In one particular embodiment, coating 230 is a silicon-doped boron nitride coating {B(Si)N}. In other embodiments, coating 230 is a graded coating of boron nitride to silicon doped boron nitride.

The B(Si)N coating can be thought of chemically as an atomic mixture of boron nitride (BN) and silicon nitride (Si₃N₄), which can be amorphous or crystalline in nature. Different levels of silicon doping would correspond to different ratios of BN to Si₃N₄, and a complete range of B(Si)N compositions can be envisioned from pure BN to pure Si₃N₄. At one extreme of this range, pure BN gives good fiber-matrix debonding characteristics for a ceramic matrix composite, but the oxidation/volatilization resistance is poor. At the other extreme, pure Si₃N₄ has very good oxidation/volatilization resistance, but does not provide a weak fiber-matrix interface for fiber debonding during composite failure. At intermediate compositions, there exists a range of silicon contents where the B(Si)N provides both good fiber-matrix debonding characteristics and has good environmental stability. A range of silicon weight percent in the B(Si)N coating is about 5 to about 40 weight percent, and preferably about 10 to about 25 weight percent, and most preferably about 11 to about 19 weight percent silicon.

In addition to at least a B(Si)N coating, other configurations containing B(Si)N can also be used, such as multiple layers of B(Si)N with initial and/or intermediate carbon layers, or an initial layer of B(Si)N followed by further coatings of silicon carbide or Si₃N₄, or with additional layers of a silicon-wettable coating over the B(Si)N, such as carbon, or combinations of the above.

Still further examples of coatings used in combination with a B(Si)N coating on the fibers or fibrous material are: boron nitride and silicon carbide; boron nitride, silicon nitride; boron nitride, carbon, silicon nitride, etc. Examples of further coatings on the fibrous material that can be utilized include but are not limited to nitrides, borides, carbides, oxides, silicides, or other similar ceramic refractory material. Representative of ceramic carbide coatings are carbides of boron, chromium, hafnium, niobium, silicon, tantalum, titanium, vanadium, zirconium, and mixtures thereof. Representative of the ceramic nitrides useful in the present process are the nitrides of hafnium, niobium, silicon, tantalum, titanium, vanadium, zirconium, and mixtures thereof. Examples of ceramic borides are the borides of hafnium, niobium, tantalum, titanium, vanadium, zirconium, and mixtures thereof. Examples of oxide coatings are oxides of aluminum, yttrium, titanium, zirconium, beryllium, silicon, and the rare earths. The thickness of the coatings may range between about 0.3 to 5 micrometers.

As stated, the fibrous material may have more than one coating. An additional protective coating may be wettable with silicon and be about 500 Angstroms to about 3 micrometers. Representative of useful silicon-wettable materials is elemental carbon, metal carbide, a metal coating which later reacts with molten silicon to form a silicide, a metal nitride such as silicon nitride, and a metal silicide. Elemental carbon is preferred and is usually deposited on the underlying coating in the form of pyrolytic carbon. Generally, the metal carbide is a carbide of silicon, tantalum, titanium, or tungsten. Generally, the metal silicide is a silicide of chromium, molybdenum, tantalum, titanium, tungsten, and zirconium. The metal which later reacts with molten silicon to form a silicide must have a melting point higher than the melting point of silicon and preferably higher than about 1450° C. Usually, the metal and silicide thereof are solid in the present process. Representative of such metals is chromium, molybdenum, tantalum, titanium, and tungsten.

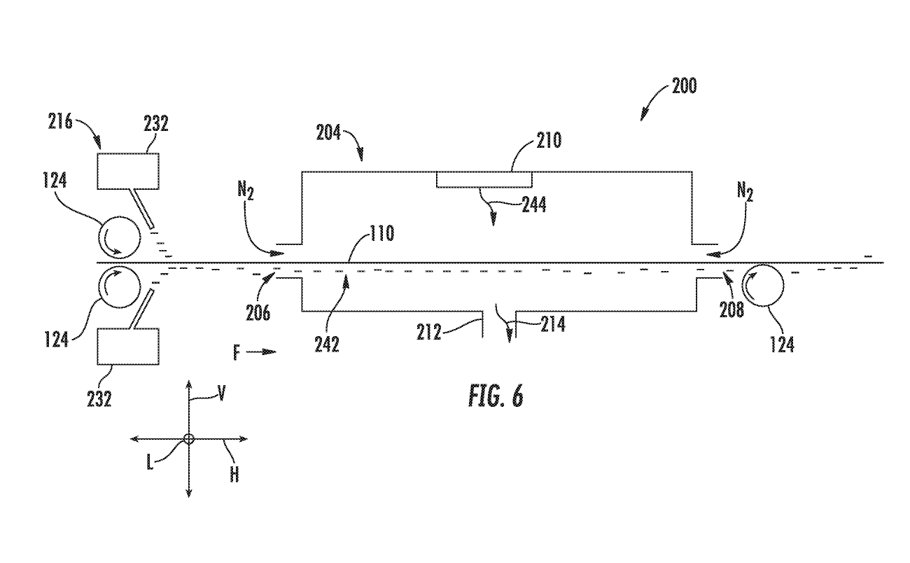

FIG. 6 is a schematic side view of another exemplary coating system 200 according to exemplary embodiments of the present disclosure. More specifically, FIG. 6 depicts a plurality of filaments 110 being charged by charging guns 232.

For this embodiment, the charging element 216 is a pair of charging guns 232 located preceding the coating chamber 204. The charging guns 232, which may be electron guns, ion guns, a charged particle generator, or a combination thereof for example, charge the plurality of filaments 110. In this embodiment, charging guns 232 are electron guns that deposit electrons onto the filaments 110. In this way, the filaments 110 become negatively charged as shown by the negative signs 242 along the filaments 110.

One charging gun 232 is positioned vertically above the plurality of filaments 110 and one charging gun 232 is positioned vertically below the plurality of filaments 110. Positioning charging guns 232 above and below the plurality of filaments 110 may better ensure that each filament 110 is charged. However, any suitable number of charging guns 232 positioned vertically above or below the plurality of filaments 110 is contemplated. The charging guns 232 charge the plurality of filaments 110 such that the filaments 110 are in the expanded spatial relationship during coating deposition.

Although not shown, the exemplary coating system 200 of FIG. 6 may include controller 226, sensors 228, a second charging element 220, which could be a charging roller 218 or charging guns 232 for example, a dissipating element 222, or any other element depicted or described with regard to the other exemplary embodiments noted herein.

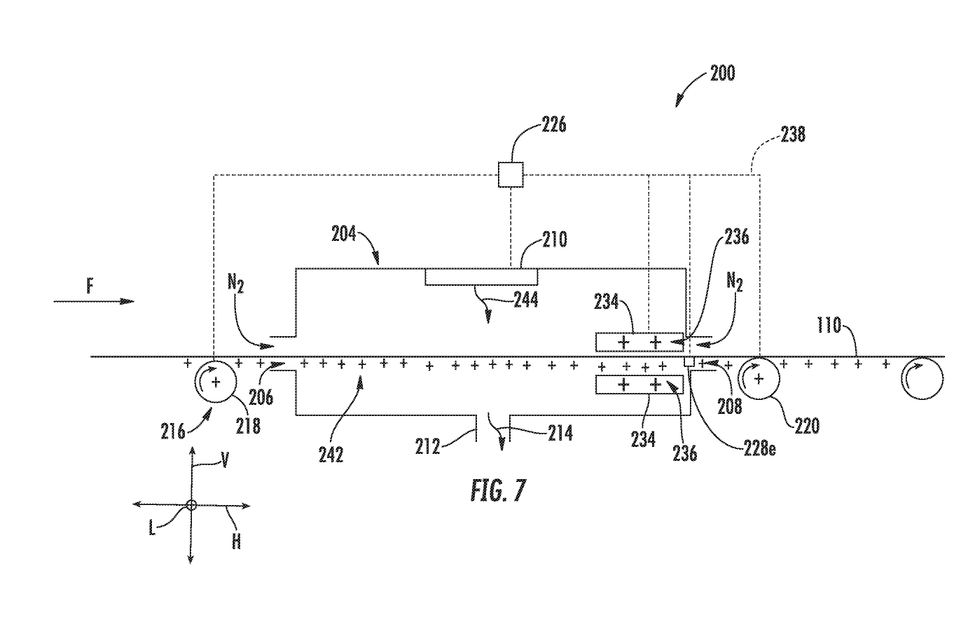

FIG. 7 is a schematic side view of another exemplary coating system 200 according to exemplary embodiments of the present disclosure. For this embodiment, prior to entering the coating chamber 204, the plurality of filaments 110 are charged by contacting positively charged charging element 216 as they are drawn or fed along the flowpath F. Charging element 216 is a charged roller 218 in this embodiment. The filaments 110 are charged with a positive charge, denoted by the plus signs 240 along the filaments 110. After being charged, the charged filaments 110 enter the coating chamber 204 through entrance slit 206. As the filaments 110 are charged with the same electrical sign or like charge, the filaments 110 are spaced apart in the expanded spatial relationship while they are coated by coating apparatus 210. In this embodiment, coating apparatus 210 is a CVD machine.

After coating and prior to exiting the coating chamber 204, the filaments 110 are drawn or fed through opposed inducing elements 234, which are opposed parallel plates in this embodiment. One inducing element 234 is positioned vertically above the filaments 110 and one inducing element 234 is positioned vertically below the filaments 110. It will be appreciated that any suitable number of inducing elements 234 can be positioned vertically above or below the plurality of filaments 110. Moreover, it will also be appreciated that the opposed inducing elements 234 can be positioned on each side of the filaments 110 as they are drawn or fed along flowpath F. In some embodiments, the inducing elements 234 can be positioned both vertically above and below as well as on both sides of the filaments 110 as they are drawn or fed along flowpath F.

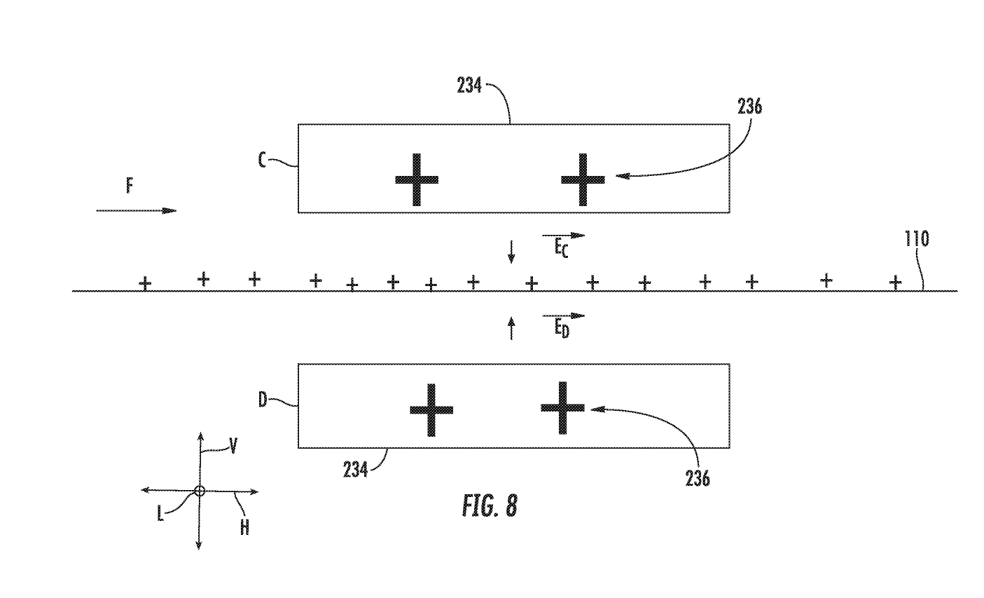

Referring now to both FIGS. 7 and 8, FIG. 8 is a side, close-up view of the filaments 110 being drawn or fed through opposed inducing elements 234 of FIG. 7. For this embodiment, the opposed inducing elements C and D are both positively charged and are charged with a much greater charge than the charged filaments 110, as denoted by the large plus signs 236 on each of the opposed inducing elements 234. By way of example, the filaments 110 could be charged with 100 V by charging element 216 and the opposed inducing elements 234 could each be charged with 1000 V.

As the filaments 110 pass through the opposed inducing elements 234, inducing element C applies an electric field \vec{E_{C}} on the filaments 110 in a generally downward vertical direction V and inducing element D applies an electric field \vec{E_{D}} on the filaments 110 in a generally upward vertical direction V as shown in FIG. 8. Due to the fact that the inducing elements C, D are charged with a much greater charge than the charge on the filaments 110, the forces produced by the electric fields \vec{E_{C}}, \vec{E_{D}} overcome the repulsive forces between the charged filaments 110 and minimize the spacing between the filaments 110. In this way, the filaments 110 are pushed closer together by the opposed electric fields \vec{E_{C}}, \vec{E_{D}}. Thus, the filaments 110 are placed in a minimized spatial relationship. Advantageously, when the filaments 110 are in a minimized spatial relationship, the filaments 110 experience less “fuzz” and broken ends and are less likely to “catch” on the slits 206, 208 of the coating chamber 204.

The opposed inducing elements 234 can be charged with any suitable amount of charge that can overcome the repulsive forces between the filaments 110 such that the filaments 110 are placed in a minimized relationship. The charge on the opposed inducing elements 234 may be adjustable. For the embodiment of FIG. 7, a controller 226 is configured to adjust the charge on the inducing elements 234 such that filaments 110 are in the minimized spatial relationship when the filaments 110 exit the coating chamber 204 through the exit slit 208. A fifth sensor 228e positioned at or adjacent the exit slit 208 can monitor the spatial relationship of the filaments 110 exiting the coating chamber 204 through exit slit 208. Fifth sensor 228e is in operative communication 238 with the controller 226. Fifth sensor 228e can detect and measure the spacing between the filaments 110 or can measure the charge on the filaments 110, for example. Fifth sensor 228e reports the collected data to controller 226 and controller 226 adjusts the charge on one or both of the inducing elements 234 as needed to create a minimized spatial relationship between the filaments 110.

Although not shown, the exemplary coating system 200 of FIG. 7 may include other sensors 228, a second charging element 220, a dissipating element 222, or any other element depicted or described with regard to the other exemplary embodiments noted herein.

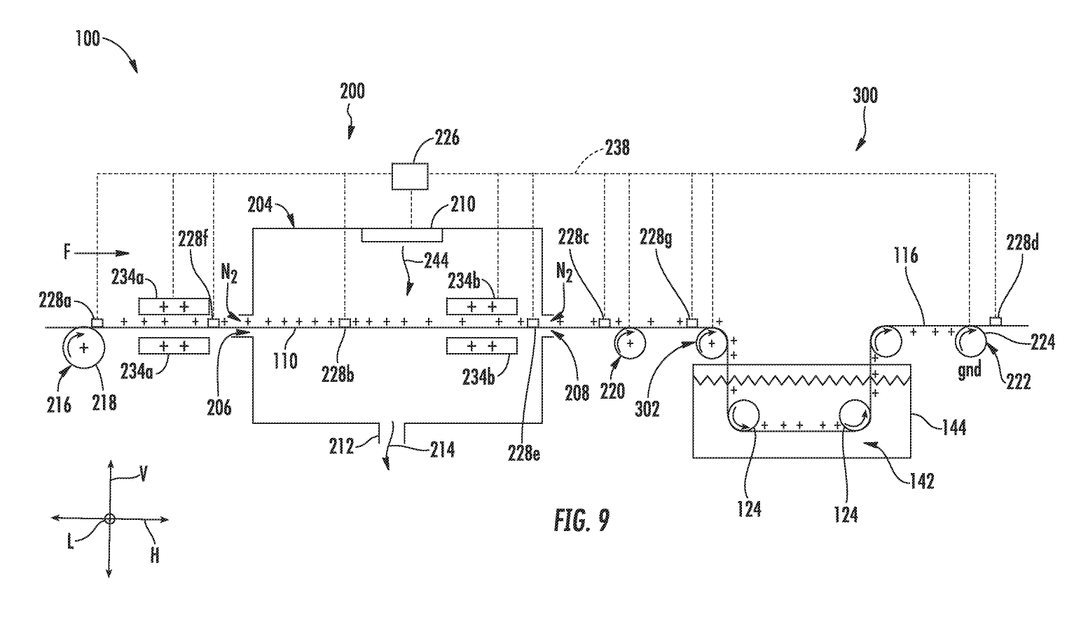

FIG. 9 is a schematic side view of an exemplary coating system 200 and exemplary impregnation system 300 for fabricating a CMC component according to an exemplary embodiment of the present subject matter.

After being unwound, the plurality of filaments 110 are drawn or fed over charging element 216, which is a charged roller 218 in this embodiment. Charging element 216 charges the filaments 110 with the same electric sign, which is a positive sign in this embodiment. After being charged, the filaments 110 become spaced apart in the expanded spatial relationship. Prior to entering coating chamber 204, the filaments 110 are drawn or fed through first opposed inducing elements 234a. The first opposed inducing elements 234a apply opposed electric fields on the filaments 110 such that the filaments 110 become in a minimized spatial relationship as they enter through the entrance slit 206 of the coating chamber 204.

A sixth sensor 228f positioned along the flowpath F and at or adjacent the entrance slit 206 can monitor the spatial relationship of the filaments 110 entering the coating chamber 204 through the entrance slit 206. Sixth sensor 228f is in operative communication 238 with the controller 226. Sixth sensor 228f can detect and measure the spacing between the filaments 110 or can measure the charge on the filaments 110, for example. Sixth sensor 228f reports the collected data to controller 226 and controller 226 adjusts the charge on one or both of the first inducing elements 234a as needed to create a minimized spatial relationship between the filaments 110.

After passing through the entrance slit 206, the filaments 110 move forward into the coating chamber 204. As the filaments 110 are no longer in proximity to the first opposed inducing elements 234a and the filaments 110 are still charged with the same electric sign or like charge, the filaments 110 become spaced apart from one another such that they are in the expanded spatial relationship. Coating apparatus 210 deposits the coating material via gas diffusion 244 on the filaments 110 while the filaments 110 are the in the expanded spatial relationship.

After coating, the filaments 110 move forward along the flowpath F and are drawn or fed through second opposed inducing elements 234b before exiting through the exit slit 208 of the coating chamber 204. The second opposed inducing elements 234b apply opposing electric fields to the filaments 110, causing the filaments 110 to have a minimized spatial relationship between one another. The filaments 110 exit through the exit slit 208 while in the minimized spatial relationship.

After exiting the coating chamber 204, the filaments 110 are drawn over a second charging element 220 to ensure that an unsafe amount or level of current is not being drawn through the filaments 110. In this embodiment, the positively charged second charging element 220 is the same electric sign as the charging element 216 to guard against surges of current through the filaments 110.

Continuing along the flowpath F of the exemplary CMC component fabrication process 100, the filaments 110 are drawn or fed through the impregnation system 300. More particularly, the filaments 110 are drawn or fed over a third charging element 302. The third charging element 302 recharges the filaments 110 in much the same way as the charging element 216. The third charging element 302 charges the filaments 110 such that they become in an expanded spatial relationship.

A seventh sensor 228g in operative communication 238 with controller 226 is positioned along the flowpath F and preceding the third charging element 302. The seventh sensor 228g monitors the amount of charge on the filaments 110 before they are drawn or fed over the third charging element 302 and reports the collected data to the controller 226. The controller 226 then adjusts the charge on third charging element 302 as needed to create an expanded spatial relationship on the filaments 110. It will be appreciated that the filaments 110 may already be in an expanded spatial relationship and therefore third charging element 302 would need to charge the filaments 110 with minimal or no charge at all.

After being charged by third charging element 302, the filaments 110 are pulled through the matrix slurry vessel 144 containing a matrix slurry 142 by rollers 124. The expanded spatial relationship of the filaments 110 enables better distribution of the matrix slurry 142 about the filaments 110, leading to better processability of the filaments 110 as well as better mechanical properties of the resultant CMC component.

After being pulled through the matrix slurry vessel 144, the filaments 110 become bonded together to form a tow 116 which is drawn or fed over a dissipating element 222, which is a grounded roller 224 in this embodiment. The dissipating element 222 dissipates the charge on the tow 116. In this way, the tow 116 can be further processed more safely, among other benefits. In some embodiments, the dissipating element 222 could be the wet drum 152 (FIG. 1) on which the tow 116 is wound to form the prepreg tape 154 (FIG. 1).

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. A method for forming a CMC component that includes a plurality of filaments that are at least partially electrically conductive, the method comprising:
charging the plurality of filaments with an electrical charge such that adjacent filaments are in an expanded spatial relationship relative to one another; and
coating the plurality of filaments while the plurality of filaments are in the expanded spatial relationship.

2. The method of claim 1, wherein the plurality of filaments are coated with a silicon-doped boron nitride coating.

3. The method of claim 1, wherein each filament of the plurality of filaments comprises an outer surface, wherein the outer surface of each filament is substantially covered with a coating.

4. The method of claim 1, wherein after coating, the method further comprises:
charging the plurality of filaments with the electrical charge such that the plurality of filaments are in the expanded spatial relationship; and
pulling the plurality of filaments through a matrix slurry bath while the plurality of filaments are in the expanded spatial relationship.

5. The method of claim 1, wherein the method further comprises:
dissipating the electrical charge with a dissipating element.

6. The method of claim 1, wherein after coating, the method further comprises:
pulling the plurality of filaments through a matrix slurry while the plurality of filaments are in the expanded spatial relationship.

7. The method of claim 1, wherein when the plurality of filaments are in the expanded spatial relationship, each filament is spaced apart from adjacent filaments by about 1 to about 100 micrometers (10⁻⁶ m).

8. The method of claim 1, wherein when the plurality of filaments are in the expanded spatial relationship, each filament is spaced apart from adjacent filaments by about 1 to about 10 micrometers (10⁻⁶ m).

9. The method of claim 1, wherein the plurality of filaments are coated in a coating chamber having an entrance slit, wherein the method further comprises:
applying opposed electric fields to the plurality of filaments such that the plurality of filaments are in a minimized spatial relationship when entering through the entrance slit.

10. The method of claim 1, wherein the plurality of filaments are coated in a coating chamber having an exit slit, wherein the method further comprises:
applying opposed electric fields to the plurality of filaments such that the plurality of filaments are in a minimized spatial relationship when exiting through the exit slit.

11. The method of claim 10, wherein the opposed electric fields are generated by opposed inducing elements positioned vertically above and below the plurality of filaments.

12. A system defining a flowpath for forming a CMC component including a plurality of filaments, the system comprising:
a coating chamber positioned along the flowpath and having a coating apparatus for coating the plurality of filaments;
a charging element positioned along the flowpath and preceding the coating apparatus, the charging element configured to charge the plurality of filaments with an electrical charge such that adjacent filaments are in an expanded spatial relationship relative to one another.

13. The system of claim 12, wherein the charging element is a charging gun positioned preceding the coating chamber.

14. The system of claim 12, wherein a second charging element is positioned along the flowpath and succeeding the coating chamber, the second charging element being charged with the same electrical sign as the charging element.

15. The system of claim 12, wherein the coating apparatus substantially covers each filament of the plurality of filaments with a silicon-doped boron nitride coating.

16. The system of claim 12, wherein the coating chamber has an exit, the system further comprising:
opposed inducing elements positioned along the flowpath and succeeding the coating apparatus and preceding the exit, the inducing elements located on opposite sides of the plurality of filaments and configured to apply opposing electric fields such that the plurality of filaments are in a minimized spatial relationship when drawn or fed through the exit.

17. The system of claim 12, wherein the system further comprises:
a second charging element positioned along the flowpath and succeeding the coating chamber;
a matrix slurry bath positioned along the flowpath and succeeding the second charging element; and
a dissipating element positioned along the flowpath and succeeding the matrix slurry bath.

18. The system of claim 12, wherein the coating chamber has an entrance and an exit, the system further comprising:
first opposed inducing elements positioned along the flowpath and preceding the entrance, the first opposed inducing elements located on opposite sides of the plurality of filaments and configured to apply opposed electric fields such that the plurality of filaments are in a minimized spatial relationship when drawn or fed through the entrance; and
second opposed inducing elements positioned along the flowpath and succeeding the coating apparatus and preceding the exit, the second opposed inducing elements located on opposite sides of the plurality of filaments and configured to apply opposed electric fields such that the plurality of filaments are in a minimized spatial relationship when drawn or fed through the exit.

19. The system of claim 12, further comprising:
a sensor positioned along the flowpath and within the coating chamber;
a controller in operative communication with the sensor and the charging element, the controller configured to:
receive data from the sensor relating to a spatial relationship between the plurality of filaments; and
adjust the charge on the charging element based on the data.

20. A method for forming a CMC component that includes a plurality of filaments that are at least partially electrically conductive, the method comprising:
charging the plurality of filaments with an electrical charge such that adjacent filaments are in an expanded spatial relationship relative to one another; and
pulling the plurality of filaments through a matrix slurry while the plurality of filaments are in the expanded spatial relationship.
